(19) United States
(12) Patent Application Publication
(10) Pub. No.: US 2011/0140336 A1
(43) Pub. Date: Jun. 16, 2011

(54) POST-PROCESSING APPARATUS, IMAGE FORMING SYSTEM

(75) Inventor: Yu TANAKA, Yokohama-shi (JP)

(73) Assignee: KONICA MINOLTA BUSINESS TECHNOLOGIES, INC., Tokyo (JP)

(21) Appl. No.: 12/959,563

(22) Filed: Dec. 3, 2010

(30) Foreign Application Priority Data
Dec. 16, 2009 (JP) JP2009-284902

(51) Int. Cl. B41L 43/12

(52) U.S. Cl. 270/37

(57) ABSTRACT

A post-processing apparatus includes: a sheet conveyance section; a side stitching section having a side stitching stacker which has a side stitching sheet stacking surface inclined with respect to a horizontal; and a saddle stitching section having a saddle stitching stacker which has a saddle stitching sheet stacking surface inclined with respect to the horizontal, wherein an inclination angle of the side stitching sheet stacking surface with respect to the horizontal and an inclination angle of the saddle stitching sheet stacking surface with respect to the horizontal are equal to each other, and the side stitching sheet stacking surface and the saddle stitching sheet stacking surface are parallel to each other.

### RELATED APPLICATION

This application is based on Japanese Patent Application NO. 2009-284902 filed on Dec. 16, 2009 in Japanese Patent Office, the entire content of which is hereby incorporates by reference.

### BACKGROUND OF THE INVENTION

1. Technical Field

The present invention relates a post-processing apparatus used by connecting with an image forming apparatus such as a copier and a printer, and an image forming system constituted by connecting the aforesaid post-processing apparatus with the image forming apparatus.

2. Background Technology

The post-processing apparatus is generally used in a form of an image forming system in which the post-processing apparatus is connected with an image forming apparatus such as a copier and a printer, and receives successively sheets of paper on which images were formed by the image forming apparatus, carries out post-processing such as stitching, making holes, folding, and then ejects the processed sheets of paper to the outside of the apparatus.

There is a post-processing apparatus equipped with a stacker which successively stacks received sheets of paper, which apparatus successively stacks the received sheets of paper in the stacker to make a bundle of sheets of paper (hereinafter referred to as a sheet bundle), after which carries out post-processing to the sheet bundle.

For example, in case where stitching, in which the prescribed positions of surroundings of the sheets of paper are stitched (hereinafter referred to as a side stitching), is carried out, multiple sheets of paper are successively stacked on a stacker to make a sheet bundle, and then, prescribed positions at an end of the sheet bundle are stitched using a stitching needle to make a booklet, after which the booklet is ejected to the outside of the apparatus.

In case where stitching, in which the center of the sheets of paper are stitched (hereinafter referred to as a saddle stitching), is carried out, multiple sheets of paper are successively stacked on a stacker to make a sheet bundle, the center positions of the center-spread of the sheet bundle are stitched (the saddle stitching) using a stitching needle. Then, usually, the folding processing, in which the spread of the sheet bundle, in which a saddle stitching was carried out, is folded at the center position taken as the folding center line, is carried out to make a booklet, after which the booklet is ejected to the outside of the apparatus.

There is a post-processing apparatuses, which is provided with the side stitching section having such a side stitching function and the saddle stitching section having a saddle stitching function, and there has been disclosed a technology (for example, Japanese Patent Application Publication (hereinafter also referred to as JP-A) No. 2003-89463), in which each of the side stitching and saddle stitching sections independently has a stacker, and sheets of paper are successively stacked in each stacker, and then, the formed sheet bundle is subjected to the side stitching and the saddle stitching. In the post-processing apparatus disclosed in JP-A No. 2003-89463, the stacker of the side stitching section is arranged with the sheets stacking surface being inclined. A sheet of paper, which will be subjected to the side stitching, is discharged in the upper part of the sheets stacking surface, followed by sliding down along the inclined sheets stacking surface, and then, stopped by the end of the sheet being brought into contact with a sheet stopper, which is disposed at a lower end of the sheets stacking surface, to be stacked on the sheets stacking surface. The above steps, the discharge of the sheet of paper in the upper part of the sheets stacking surface, the slide down along the inclined sheets stacking surface, and the stop by its end being brought into contact with a sheet stopper, are repeated, and as a result the sheets of paper are successively stacked on the sheets stacking surface. When the prescribed number of sheets is stacked and a sheet bundle is formed, the prescribed positions of the sheet bundle are stitched, and thereby the side stitching is carried out.

### SUMMARY OF THE INVENTION

The stacker, which stacks sheets of paper, requires sufficient length and width to support the stacked sheets, and thereby, becomes an important element to determine the size of the post-processing apparatus.

In the post-processing apparatus disclosed in JP-A No. 2003-89463, there is arranged a stacker of a saddle stitching section having a nearly vertical sheet stacking surface at a lower part of a stacker of a side stitching section, which is arranged with the sheet stacking surface being inclined, and thereby the height of the post-processing apparatus is increased

It is effective for making the post-processing apparatus smaller to decrease the length of the stacker, specifically the length of the sheets stacking surface. However, when a sheet, longer than the length of the sheet stacking surface of a stacker, is subjected to a post-processing, an end of the sheet stacked in the stacker is projected from an end of the stacker, and thereby the end of the sheet is sometimes exposed out of the post-processing apparatus.

The sheet of paper, the end of which was exposed out of the case of the post-processing apparatus, is liable to be affected by airflow in an installation environment of the post-processing apparatus. For example, if an end portion of sheets of paper, which is exposed out of the case of the post-processing apparatus, is blown by airflow from an air conditioner, the Alignment of the sheet bundle, stacked in a stacker, is often disturbed. When a sheet bundle with its alignment having been disturbed is subjected to a side stitching or a saddle stitching, a booklet with the alignment being disturbed is unpreferably formed.

On the other hand, if the length of the stacker is increased, the sheet of paper becomes hard to be affected by airflow in an installation environment of the post-processing apparatus, since a length of the sheet projected from the stacker can be decreased. However, a simple increase in length of the stacker unpreferably leads to a larger size of the post-processing apparatus.

If the stacker is arranged in the post-processing apparatus with an inclined angle of the sheet stacking surface being increased, the length of the stacker can be increased even in a limited floor area. However, the sheet, stacked with its end being brought into contact with a sheet stopper, may be subjected to buckling distortion. If the sheet stacked in the stacker is subjected to buckling distortion, misalignment of sheets is caused when the succeeding sheets of paper are stacked in the stacker, which misalignment may cause formation of a booklet with its alignment being disturbed by stitching processing.

The inventions of the present application are the followings:

1. A post-processing apparatus comprising:

a sheet conveyance section to convey a sheet along a conveyance path;

a side stitching section including a side stitching stacker which has a side stitching sheet stacking surface inclined with respect to a horizontal and stacks the sheet conveyed by the sheet conveyance section and discharged upward of the side stitching sheet stacking surface, at a predetermined position of the side stitching sheet stacking surface by sliding down the sheet along the inclined side stitching sheet stacking surface, the side stitching section carrying out a side stitching for stitching a prescribed position of a surrounding of the sheet stacked on the side stitching sheet stacking surface; and

a saddle stitching section including a saddle stitching stacker which has a saddle stitching sheet stacking surface inclined with respect to the horizontal and stacks the sheet conveyed by the sheet conveyance section and discharged upward of the saddle stitching sheet stacking surface, at a predetermined position of the saddle stitching sheet stacking surface by sliding down the sheet along the inclined saddle stitching sheet stacking surface, the saddle stitching section carrying out a saddle stitching for stitching a prescribed position of a center portion in a sheet feeding direction of the sheet stacked on the saddle stitching sheet stacking surface,

wherein an inclination angle of the side stitching sheet stacking surface with respect to the horizontal and an inclination angle of the saddle stitching sheet stacking surface with respect to the horizontal are equal to each other, and the side stitching sheet stacking surface and the saddle stitching sheet stacking surface are parallel to each other.

2. The post-processing apparatus of claim 1, wherein the inclination angles of the side stitching sheet stacking surface and the saddle stitching sheet stacking surface with respect to the horizontal are made 40 to 60 degrees.

3. The post-processing apparatus of claim 1, wherein a surface of the sheet to be stacked on the side stitching sheet stacker facing the side stitching sheet stacking surface and a surface of the sheet to be stacked on the saddle stacker facing to the saddle stitching sheet stacking surface are a same side surface of the sheet to be conveyed to either of the side stitching section and the saddle stitching section.

4. The post-processing apparatus of claim 1, wherein the side stitching section is provided above the saddle stitching section.

5. An image forming system comprising an image forming apparatus connecting to the post-processing apparatus of claim 1.

### BRIEF DESCRIPTION OF DRAWINGS

FIG. 1 is an overall view of an image forming system which is composed by connecting a post-processing apparatus FS which is an embodiment of the present invention, with an image forming apparatus A.

FIG. 2 is a figure describing an arrangement manner of a side stitching section 30 and a saddle stitching section 40 in the post-processing apparatus FS.

### PREFERRED EMBODIMENT OF THE INVENTION

Hereinafter, with reference to figures, described will be a post-processing apparatus, which is an example of an embodiment of the present invention, and an image forming system which is composed by connecting the post-processing apparatus with an image forming apparatus. The present invention is not limited to an embodiment described below.

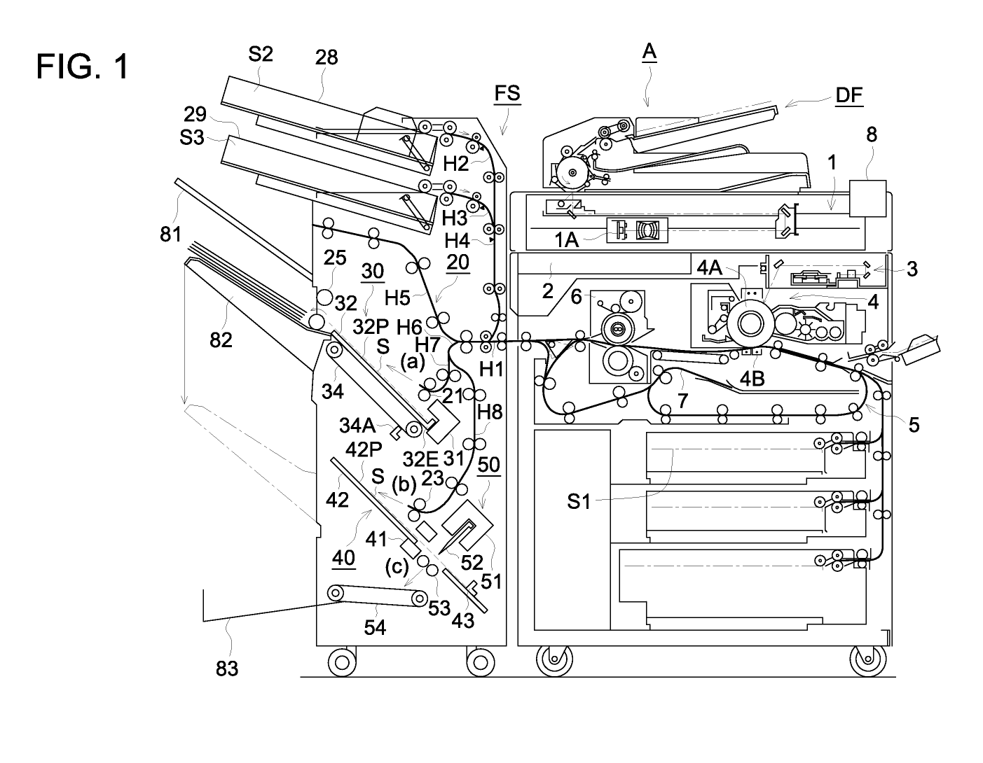

FIG. 1 is an overall view of an image forming system which is composed by connecting a post-processing apparatus, an embodiment of the present invention, with an image forming apparatus A.

The illustrated image forming apparatus A is equipped with an original document reading unit 1, an image processing unit 2, an image writing unit 3, an image forming unit 4, a sheet conveying unit 5, a fixing unit 6, a sheet reversing conveyance unit (ADU) 7, an operation display unit 8, and a control unit 9 (not illustrated).

The operation display unit 8 functions as an input means unit to input job information so that a user runs the image forming apparatus A and the connected post-processing apparatus FS.

From the operation display unit 8, it is possible to input information, as the job information, such as a selection of a sheet size or the number of sheets to run the image forming apparatus A, and a selection whether a side stitching or a saddle stitching is carried out to run the connected post-processing apparatus FS, and further, when getting the apparatus to do the side stitching or the saddle stitching, the number of sheets which are stitched together into a booklet. The operation display unit 8 is provided with a start button, and when a user presses the start button, the user can start motions, which are based on the job information input in the operation display unit 8, of the image forming apparatus A and the post-processing apparatus FS.

The control unit 9 controls the image forming motion of the image forming apparatus A on the basis of the job information containing stitching information which was designated by a user and was input from the operation display unit 8, and at the same time, controls the post-processing apparatus FS to get it work in conjunction with the image forming motion of the image forming apparatus A.

On the upper part of the image forming apparatus A, an automatic document feeding apparatus DF is equipped. The image of the original document fed from the automatic document feeding apparatus DF is read by an optical system of the original document reading unit 1, and then, read into a CCD image sensor 1A.

An analogue signal photoelectrically converted by the CCD image sensor 1A is subjected to an analogue processing, an A/D conversion, a shading compensation, an image compression processing, and the like at the image processing unit 2, after which the processed signal is sent to the image writing unit 3.

When an image formation is carried out, output light based on image information is emitted from a semiconductor laser of the image writing unit 3, and then a photosensitive drum 4A of the image forming unit 4 is irradiated to form a latent image. The latent image on the photosensitive drum 4A is developed to a toner image. A sheet S1 fed by the sheet conveyance unit 5 makes a contact with the photosensitive drum 4A, whereby the toner image is transferred onto the sheet S1 by a transfer means 4B. The sheet S1, on which the toner image is supported, is subjected to a fixing treatment by the fixing unit 6, after which the sheet S1 is sent to the post-processing apparatus FS. When the double-sided copy is made, the sheet S1, in which an image on one side of the sheet has been processed, is delivered to the sheet reversing conveyance unit 7, and the front and back sides are reversed, and then a toner image is transferred onto the back side of the sheet of paper at the image forming unit 4, after which the image is fixed, and the sheet of paper is ejected.

The post-processing apparatus FS is equipped with a sheet conveyance section 20, a side stitching section 30, a saddle stitching section 40, and a center folding section 50, all of which are operated by a control of a non-illustrated post-processing control unit 90.

When the post-processing control unit 90 operates the post-processing apparatus FS, information, such as a selection whether a user carries out a side stitching or a saddle stitching, and a selection of how many sheets are stitched when a stitching is carried out, is transmitted as job information from the control unit 9 of the image forming apparatus A, based on a input result from the operation display unit 8 of the image forming apparatus A.

An insertion sheet S2 and the other insertion sheet S3 are loaded in an insertion sheet feeding unit 28 and an insertion sheet feeding unit 29, respectively. The insertion sheets S2 and S3 are insertion sheet of paper such as an insertion sheet and a sheet used for a cover sheet, which is inserted between multiple sheets S1, which are ejected from the image forming apparatus A, and the insertion sheets can be subjected to a stitching processing or a folding processing similarly to the sheet S1.

In the descriptions below, the sheet S1, the insertion sheets S2 and S3 are collectively referred to as the sheets S.

The sheet conveyance section 20 has multiple conveyance paths which are provided with multiple rollers driven by a non-illustrated motor, and conveys the sheets S under the control of the post-processing control unit 90.

The post-processing control unit 90 controls a motion of the sheet conveyance section 20 based on job information transmitted from the image forming apparatus A, and conveys a sheet at an appropriate conveyance path at just a right moment to carry out a post-processing based on the job information.

The sheet S1, ejected from the image forming apparatus A, is introduced into the inside through a conveyance path Hi of the sheet conveyance section 20.

The insertion sheet S2, loaded in the insertion sheet feeding unit 28, is conveyed through conveyance paths H2 and H4, joins the conveyance path H1, and then introduced into the inside through the conveyance path H1.

The insertion sheet S3, loaded in the insertion sheet feeding unit 29, is conveyed through a conveyance path H3, joins the conveyance path H4, and then introduced into the inside through the conveyance path H1.

The conveyance path H1 is branched off into a conveyance path H5 and a conveyance path H6, and the conveyance path H6 is branched off into a conveyance path H7 and a conveyance path H8.

The conveyance path H5 is a sheet ejection path in which the sheets S are ejected onto a fixed ejection sheet tray 81. The conveyance path H7 is a conveyance path toward the side stitching section, and the conveyance path H8 is a conveyance path toward the saddle stitching section.

The fixed ejection sheet tray 81 is disposed at a position downstream of the conveyance path H5 which is branched off from the conveyance path H1, which position is projected outside the post-processing apparatus FS.

The fixed ejection sheet tray 81 collects the aforesaid sheets S which were conveyed through the conveyance path H5.

The side stitching section 30 is equipped with a stapler 31 and a side stitching stacker 32, and stitching with a stitching needle is carried out by the stapler 31 at prescribed positions at an end surface portion of a bundle of the sheets S, which was stacked on the side stitching stacker 32, to form a booklet, after which the booklet is ejected to an elevating sheet ejection tray 82.

The side stitching stacker 32 is equipped with a side stitching sheet stacking surface 32P, and is disposed in a manner that the left of the side stitching sheet stacking surface 32P in the figure is inclined upward with respect to a horizontal.

The sheets S conveyed through the conveyance path H7 are pushed out by the conveyance rollers 21 toward an arrow direction (a) into the left space of the conveyance rollers 21 in the figure, and, when the rear end of the sheets S in the conveyance direction are separated from the conveyance rollers 21, the sheets S are discharged upward of the side stitching stacker 32 (the side stitching sheet stacking surface 32P).

The sheets P, discharged upward of the side stitching sheet stacking surface 32P, drop onto the side stitching sheet stacking surface 32P, and then slide down to the right in the figure along the inclined side stitching sheet stacking surface 32P, or, when the preceding sheets S are stacked on the side stitching sheet stacking surface 32P, along their upper surface. After that, the sliding end of the sheets S is caught to stop by a sheet stopper part 32E, which is arranged at the right lower end in the figure of the side stitching stacker 32, and then the sheets S is stacked in the side stitching stacker 32. There may be provided with an auxiliary member, such as a paddle, to assist the sliding of the sheets S on the side stitching stacker 32. Further, there may be provided with a mechanism to correct a position shift of the sheets S in the direction perpendicular to the conveyance direction.

When the final sheet of the sheets, which will be subjected to a side stitching, is stacked on the side stitching stacker 32 and sheets are collected to form a sheet bundle, the stapler 31 of the side stitching section 30 starts to work, and thereby a side stitching processing is carried out by stitching the prescribed positions of the surroundings of the sheet bundle using a stitching needle.

The rear end of the sheet bundle, which was subjected to the stitching processing, is held by an ejection claw 34A, and then the sheet bundle slides on the side stitching sheet stacking surface 32P to be pushed obliquely upward. After that, the sheet bundle is nipped and held by sheet ejection rollers 25, and then ejected to be stacked on the elevating sheet ejection tray 82. The elevating sheet ejection tray 82 is vertically movable by a moving means of elevating sheet ejection tray (not illustrated) which operates under the control of the post-processing control unit 90, and moves downward as the number of sheets stacked on the elevating sheet ejection tray 82 increases, and thereby a large amount of sheets can be stacked.

When the sheets S are subjected to a saddle stitching, the sheets S are conveyed downward through the conveyance path H8, which is branched off from the conveyance path H6.

The saddle stitching section 40 is equipped with a stapler 41 and a saddle stitching stacker 42, and carries out a saddle stitching by stitching, using a stitching needle, the prescribed positions of the center portion of the spread of the sheet bundle S stacked in the saddle stitching section 42. At the folding-in section 50, the sheet bundle, which was subjected to the saddle stitching, is folded in the middle (a center folding) by making the center portion of the spread of the stitched sheet bundle a folding center, which is then ejected into a lower sheet ejection tray 83.

The sheets S conveyed through the conveyance path H8 are pushed out toward an arrow direction (b) into the left space of the conveyance rollers 23 in the figure by the conveyance rollers 23, and, when the rear end of the sheets S in the conveyance direction are separated from the conveyance rollers 23, the sheets S are discharged upward of the saddle stitching stacker 42 of the saddle stitching section 40 (the saddle stitching sheet stacking surface 42P).

The sheets P, discharged upward of the saddle stitching sheet stacking surface 42P, drop onto the saddle stitching stacker 42, and then slide down along the inclined saddle stitching sheet stacking surface 42P, or, when the preceding sheets P are stacked on the saddle stitching sheet stacking surface 42P, along their upper surface. After that, the sliding end of the sheets S is caught to stop by a stopper 43, which is arranged at the right lower end in the figure of the saddle stitching stacker 42, and then the sheets S is stacked in the saddle stitching stacker 42. The stopper 43 is allowed to move along the saddle stitching sheet stacking surface 42P by a non-illustrated stopper moving mechanism part, and carries out positioning of the sheets which are stacked in the saddle stitching stacker 42. The shift of the position of the stopper 43 is carries out based on positions where the stapler 41, arranged at a prescribed position in the machine, stitches and a length of the sheet conveyance direction designated in a job, and the stopper 43 is allowed to move to a position where the stitching position becomes the center portion of the spread of the sheets which were caught by the stopper 43 (the center between a leading end and a rear end in the conveyance direction).

When the final sheet of the sheets which will be subjected to a saddle stitching is stacked on the saddle stitching stacker 42 and collection of sheets is completed, the stapler 41 of the saddle stitching section 40 starts to work, and thereby a saddle stitching processing using a stitching needle is carried out by stitching the center of the sheet bundle.

The sheet bundle, which was subjected to the saddle stitching, is subjected to center folding processing at the center folding section 50.

The center folding section 50 is equipped with a thrusting plate driving part 51, a thrusting plate 52, and a folding roller pair. The thrusting plate 52 has an acute-angled tip, and is allowed to move in a direction perpendicular to the saddle stitching sheet stacking surface 42P by the thrusting plate driving part 51.

When the sheet bundle which was subjected to a stitching processing is center folded, the stopper 43 is allowed to move.

The shift of the position of the stopper 43 is carried out based on stitching position by the above stapler 41 and a position of the thrusting plate 52 arranged at a prescribed position in the machine, and the stopper 43 is allowed to move so that a position where the sheet bundle was stitched (that is, the center portion of the sheets in the conveyance direction) becomes a position facing to the thrusting plate 52.

The tip portion of the thrusting plate 52, which is allowed to move in the direction perpendicular to the upper surface of the saddle stitching stacker 42, makes a close contact with a position where the sheet bundle stacked on the saddle stitching stacker 42 is stitched to bend the sheet bundle, and further thrusts the tip portion of the sheet bundle being bent into a nip of a bending roller pair 53. The rotating bending roller pair 53 lets the sheet bundle being thrust through the nip while nipping and holding the sheet bundle, whereby the folding of the sheet bundle along a position where the sheet bundle was stitched, namely center folding, is performed.

The sheet bundle having been subjected to the saddle stitching and the center folding, which was nipped and held by the rotating folding roller pair 53 and conveyed, is pressed out to an arrow direction (c) with the folded part being a head, and then ejected in the lower sheet ejection tray 83 by a conveyance belt mechanism 54 driven by a non-illustrated driving means.

It may be constituted in such a manner that the saddle stitching section 40, the center folding section 50, and the conveyance belt mechanism 54 are made as a unit so that the unit can easily be attached to and detached from the post-processing apparatus FS.

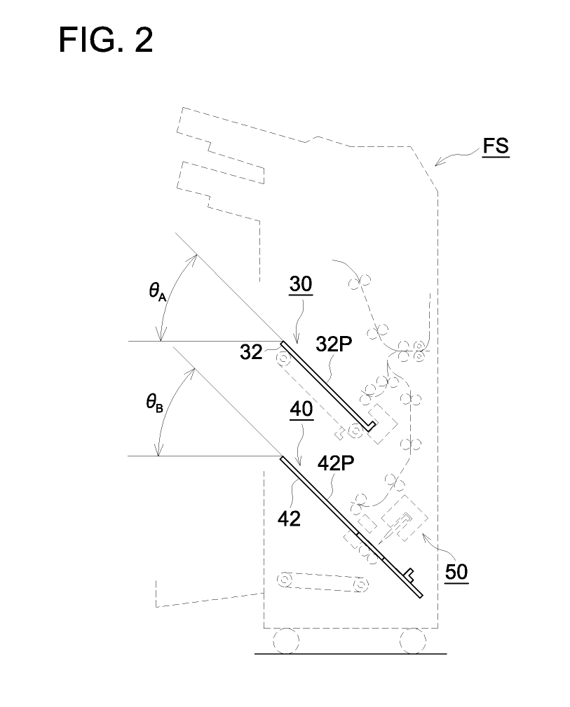

FIG. 2 is a figure describing an arrangement manner of the side stitching section 30 and the saddle stitching section 40 in the post-processing apparatus FS.

The side stitching stacker 32 of the side stitching section 30 is equipped with the side stitching sheet stacking surface 32P, the right in the figure of which being inclined downward, and the sheet stopper part 32E at the lower end of the above inclined unit. Since the sheet stopper part 32E side of the side stitching stacker 32 makes a close contact with the front end of a sheet in the sliding direction which sheet is discharged in the upper direction of the side stitching sheet stacking surface 32P and slides along the side stitching sheet stacking surface 32P, the sheet stopper part 32E side is referred to as the front end side in the sliding direction. Accordingly, the opposite side thereat that is the left in the figure, becomes the rear end side in the sliding direction. Thus, the side stitching sheet stacking surface 32P is inclined in such a manner that the rear end side in the sliding direction is facing upward with respect to the horizontal. The inclination angle of the side stitching sheet stacking surface 32P with respect to the horizontal is represented by θ_{A}.

The saddle stitching stacker 42 of the saddle stitching section 40 is equipped with the saddle stitching sheet stacking surface 42P, in which the right in the figure is inclined downward. Further, at the inclined lower end, the saddle stitching stacker 42 is equipped with the sheet stopper 43, which moves along the saddle stitching sheet stacking surface 42P. Since the sheet stopper 43 side of the saddle stitching stacker 42 makes a close contact with the front end of a sheet in the sliding direction which sheet slides along the saddle stitching sheet stacking surface 42P, the sheet stopper 43 side is referred to as the front end side in the sliding direction. Accordingly, the opposite side thereof, that is the left in the figure, becomes the rear end side in the sliding direction. Thus, the saddle stitching sheet stacking surface 42P is inclined in such a manner that the rear end side in the sliding direction is facing upward with respect to the horizontal. The inclination angle of the saddle stitching sheet stacking surface 42P with respect to the horizontal is represented by θ_{B}.

The post-processing apparatus FS of the present embodiment is constituted so that the inclination angle θ_{A} of the side stitching sheet stacking surface 32P with respect to the horizontal and the inclination angle θ_{B} of the saddle stitching sheet stacking surface 42P with respect to the horizontal are equal to each other, and the side stitching sheet stacking surface 32P and the saddle stitching sheet stacking surface 42P are parallel to each other. By making the inclination angles of the side stitching sheet stacking surface 32P and the saddle stitching sheet stacking surface 42P equal to each other, the side stitching stacker 32 of the side stitching section 30 and the saddle stitching stacker 42 of the saddle stitching section 40, each of which requires a large space, can be arranged in the post-processing apparatus FS without producing a wasted space, whereby a smaller post-processing apparatus can be designed. Then, the side stitching section 30 and the saddle stitching section 40, or the center folding section 50, which is attached to the saddle stitching section 40, can be arranged in the post-processing apparatus FS without producing a wasted space, whereby a smaller post-processing apparatus can be designed.

By making the inclination angle θ_{A} of the side stitching sheet stacking surface 32P with respect to the horizontal and the inclination angle θ_{B} of the saddle stitching sheet stacking surface 42P with respect to the horizontal equal to each other, the inclination angle θ_{A} of the side stitching sheet stacking surface 32P and the inclination angle θ_{B} of the saddle stitching sheet stacking surface 42P can be made 40 to 60 degrees, which are preferable to the sheet stacking, without making the apparatus larger. The post-processing apparatus FS of the present embodiment is constituted to be θ_{A}=θ_{B}=45 degrees.

By making the inclination angle of the sheet stacking surface 40 to 60 degrees, the sheet discharged upward of the sheet stacking surface can be smoothly slid down along the sheet stacking surface, and at the same time, since the buckling distortion is not caused to the sheet of paper or the sheet bundle, which was stopped by the front end in the sliding direction having been made close contact with the sheet stopper part, an aligned sheet bundle is formed, and thereby a high-quality booklet can be made. In the post-processing apparatus FS of the present embodiment, each of the inclination angles θ_{A} and θ_{B} of the side stitching sheet stacking surface 32P and the saddle stitching sheet stacking surface 42P respectively is equally 45 degrees, and a high-quality booklet can be made since an aligned sheet bundle is formed.

Further, by making the inclination angle θ_{A} of the side stitching sheet stacking surface 32P and the inclination angle θ_{B} of the saddle stitching sheet stacking surface 42P 40 to 60 degrees, it becomes possible to make the lengths of the side stitching sheet stacking surface 32P and the saddle stitching sheet stacking surface 42P sufficiently longer, without making the post-processing apparatus larger. Consequently, even when large size sheets of paper are stitched, the projected length of the sheets stacked on a stacker out of the apparatus due to projection of an end of the sheets from an end of the stacker, can be made shorter, and thereby the disturbance of the alignment of the sheet bundle stacked on the stacker due to airflow caused by the air conditioning system and the like is decreased, to result in a high quality stitching.

In the post-processing apparatus FS of the present embodiment, the surface of the sheets S, which were conveyed to the side stitching section 30 and stacked on the side stitching stacker 32, which surface faces the side stitching sheet stacking surface 32P side, and the surface of the sheets S, which were conveyed to the saddle stitching section 40 and stacked on the saddle stitching stacker 42, which surface faces the saddle stitching sheet stacking surface 42P side, are surfaces of the same side of the sheets S (being the sheet of paper S1 and the insertion papers S2 and S3), which are conveyed through the conveyance path H1. Therefore, even when a stitching including the insertion paper S2, which was loaded in the insertion sheet feeding section 28, or the insertion paper S3, which was loaded in the insertion sheet feeding section 29, is carried out regardless of the side stitching or the saddle stitching, the insertion paper S2 or the insertion paper S3 is stacked on the side stitching stacker 32 or on the saddle stitching stacker 42, while facing each surface of the same side of the insertion paper S2 or the insertion paper S3 to the side stitching sheet stacking surface 32P or the saddle stitching sheet stacking surface 42P. Therefore, when the side stitching or the saddle stitching is carried out, it is not required to invert front and back sides of the insertion paper S2 or the insertion paper S3, and thereby the apparatus can be simplified.

Further, in the post-processing apparatus FS of the present embodiment, the side stitching section 30 is arranged above the saddle stitching section 40. By arranging the side stitching section 30 above the saddle stitching section 40, the moving distance in the vertical direction of the elevating sheet ejection tray 82 can be extended, and thereby it becomes possible to stack a large amount of sheets of paper.

What is claimed is:

1. A post-processing apparatus comprising:
a sheet conveyance section to convey a sheet along a conveyance path;
a side stitching section including a side stitching stacker which has a side stitching sheet stacking surface inclined with respect to a horizontal and stacks the sheet conveyed by the sheet conveyance section and discharged upward of the side stitching sheet stacking surface, at a predetermined position of the side stitching sheet stacking surface by sliding down the sheet along the inclined side stitching sheet stacking surface, the side stitching section carrying out a side stitching for stitching a prescribed position of a surrounding of the sheet stacked on the side stitching sheet stacking surface; and
a saddle stitching section including a saddle stitching stacker which has a saddle stitching sheet stacking surface inclined with respect to the horizontal and equipped with stacks the sheet conveyed by the sheet conveyance section and discharged upward of the saddle stitching sheet stacking surface, at a predetermined position of the saddle stitching sheet stacking surface by sliding down the sheet along the inclined saddle stitching sheet stacking surface, the saddle stitching section carrying out a saddle stitching for stitching a prescribed position of a center portion in a sheet feeding direction of the sheet stacked on the saddle stitching sheet stacking surface,
wherein an inclination angle of the side stitching sheet stacking surface with respect to the horizontal and an inclination angle of the saddle stitching sheet stacking surface with respect to the horizontal are equal to each other, and the side stitching sheet stacking surface and the saddle stitching sheet stacking surface are parallel to each other.

2. The post-processing apparatus of claim 1, wherein the inclination angles of the side stitching sheet stacking surface and the saddle stitching sheet stacking surface with respect to the horizontal are made 40 to 60 degrees.

3. The post-processing apparatus of claim 1, wherein a surface of the sheet to be stacked on the side stitching sheet stacker facing the side stitching sheet stacking surface and a surface of the sheet to be stacked on the saddle stacker facing to the saddle stitching sheet stacking surface are a same side surface of the sheet to be conveyed to either of the side stitching section and the saddle stitching section.

4. The post-processing apparatus of claim 1, wherein the side stitching section is provided above the saddle stitching section.

5. An image forming system constituted by connecting the post-processing apparatus of claim 1 with an image forming apparatus.
